(19) United States
(12) Patent Application Publication
(10) Pub. No.: US 2026/0208852 A1
(43) Pub. Date: Jul. 23, 2026

(54) WING OF A VERTICAL TAKE-OFF AND LANDING AIRCRAFT

(71) Applicant: Ascendance Flight Technologies, Toulouse (FR)

(72) Inventors: Benoît FERRAN, Toulouse (FR); Guillermo VILAPLANA, Toulouse (FR); Vincent LHOMME, Toulouse (FR); Risshi JAIN, Toulouse (FR)

(73) Assignee: Ascendance Flight Technologies, Toulouse (FR)

(21) Appl. No.: 19/141,037

(22) PCT Filed: Dec. 18, 2023
(86) PCT No.: PCT/FR2023/052040

§ 371 Date: Jun. 18, 2025

(30) Foreign Application Priority Data
Dec. 19, 2022 (FR) FR2213793

(51) Int. Cl. B64C 7/00; B64C 3/14; B64C 3/18; B64C 27/20; B64C 27/26

(52) U.S. Cl. CPC B64C 7/00; B64C 3/14; B64C 3/185; B64C 27/20; B64C 27/26

(57) ABSTRACT

An aircraft wing portion comprises a shroud. This shroud has a leading edge and a trailing edge, a pressure-side surface and a suction-side surface. The shroud also has a through-duct connecting the pressure-side surface to the suction-side surface. The through-duct houses a rotor. The shroud comprises a front part, extending from the leading edge to the through-duct. The shroud has a profile with a front section, corresponding to its front part. The through-duct is closer to the trailing edge than to the leading edge, while the profile has a distance between the pressure-side surface and the suction-side surface that is at its maximum on its front section. This front section has a camber of less than ten percent.

The invention relates to the field of vertical take-off and landing aircraft, also referred to as VTOL in the art. More specifically, the invention relates to a VTOL aircraft wing portion, an aircraft wing including this portion and an aircraft comprising this wing.

A VTOL aircraft generally comprises a plurality of rotors equipped with blades which, when rotated, are capable of jointly producing a substantially vertical movement of the aircraft, in particular for the take-off and landing phases thereof. A VTOL aircraft can take off from and land on reduced ground infrastructure, making it particularly suitable for use in highly constrained environments, such as cities.

A first configuration of VTOL aircraft is known, in which the rotation of the rotors alone ensures the lift of the aircraft, not only in the vertical flight phases, but also in the forward flight phases. This is the case, for example, of the configuration of the aircraft known as “Volocity” by the company Volocopter. The aircraft is then generally devoid of wings. However, the aircraft of this first configuration have a relatively low forward flight speed, low energy autonomy and cause significant noise pollution.

For this reason, a second configuration is generally preferred, in which the aircraft are provided with wings. These wings produce most of the aircraft's lift in forward flight, while in vertical flight, this lift is mainly generated by the rotors.

According to a first type of aircraft having this second configuration, the rotors are installed on the wings, such that the blades of these rotors extend beyond the wings. This is the case, for example, of the aircraft known as “VX-4” from the company Vertical Aerospace. In forward flight, these rotors can either be folded to take part in forward flight, or left as they are. In the first case, implementing the folding mechanism introduces additional mechanical complexity, without necessarily resulting in a significant performance gain. In the second case, significant drag is generated.

According to a second type of aircraft having this second configuration, the wings comprise a fairing provided with through-ducts, each of these ducts connecting the pressure-side surface of the wing to the suction-side surface of the latter. The rotors are each housed in a respective duct.

For aircraft of this type, the aim is to design wings whose fairings have ducts to accommodate the rotors and whose lift-to-drag ratio (or L/D ratio) is as high as possible.

It is difficult to design such wings because constructive measures aimed at improving drag generally impair lift and vice versa. Moreover, these measures often produce different effects depending on whether the aircraft is in forward flight or in vertical flight.

For example, housing the rotors in through-ducts improves their efficiency in vertical flight. However, the presence of ducts passing through the fairing generates a discontinuity in lift on the wing and increases drag locally, particularly in forward flight.

VTOL aircraft are known whose wings are associated with shrouded rotors and mounted to tilt on these wings. These rotors ensure the propulsion of the aircraft both in the vertical flight phase and in the forward flight phase. This is the case, for example, of the aircraft known as the “Lilium Jet” from the company Lilium, whose propulsion is based on a unique, fully electrified engine system, during all flight phases. Contrary to their intended purpose, wings profiled in this way generally do not improve the lift-to-drag ratio.

For this reason, the focus here is on the wings of VTOL aircraft whose fairings have through-ducts, which house rotors dedicated to propulsion in the vertical flight phase only, or at least mainly.

U.S. Pat. No. 11,001,377 B1 , EP 3431385 A1 , EP 3290334 A1 , CN 105711831 An and CN 104176250 A disclose wings of the type described above, whose drag in forward flight is reduced by the addition of a rotor cover mechanism. However, such a mechanism is difficult to implement and poses a problem for obtaining a certificate of compliance with the regulatory requirements necessary for the marketing of any commercial aircraft.

EP 3532375 A1 discloses a wing of the type described above, wherein the drag in forward flight is reduced thanks to an acceleration of the air flow on this wing, which acceleration results from a rotation of an additional propeller, arranged at the rear of the wing. However, the presence of this propeller causes additional drag in forward flight.

EP 3470332 B1 discloses a wing of the type described above, comprising a fairing, having a leading edge and a trailing edge opposite each other, a pressure-side surface and a suction-side surface, opposite each other and each connecting the leading edge to the trailing edge. The fairing further has a through-duct which connects the pressure-side surface to the suction-side surface. This through-duct houses a rotor. The fairing comprises a front part, extending from the leading edge to the through-duct and a profile with a front section, corresponding to its front part.

The wing of EP 3470332 B1 has improved lift in forward flight, but at the expense of drag, so that overall, this wing is not entirely satisfactory.

In this context, the Applicant has sought to improve the situation.

An aircraft wing portion is proposed comprising a fairing, which has a leading edge and a trailing edge opposite each other, a pressure-side surface and a suction-side surface, opposite each other and each connecting the leading edge to the trailing edge. The fairing further has a through-duct connecting the pressure-side surface to the suction-side surface. The through-duct is able to house a rotor, at least partially. The fairing comprises a front part, extending from the leading edge to the through-duct. The fairing has a profile with a front section, corresponding to its front part. The through-duct is closer to the trailing edge than to the leading edge, while the profile has a distance between the pressure-side surface and the suction-side surface that is at its maximum on its front section. This front section has a camber of less than ten percent.

The configuration of the proposed wing portion combines a through-duct positioned behind this portion and a particular profile of this portion. This configuration significantly reduces drag in forward flight. It also allows a thicker spar to be installed, especially when compared to configurations where the spar crosses the duct, without affecting drag. This thicker spar allows ductless wing sections to be added adjacent to this wing portion. This increases the lift of the wing in forward flight. This results in a wing with a much improved lift-drag ratio.

An aircraft wing comprising this wing portion is also proposed, as is an aircraft comprising one or more of these wings.

Optional features of the invention, whether complementary or alternative, are set out below:
the front part houses a spar portion, and where the spar portion is closest to the through-duct, the front section has a chord line and the distance between the leading edge and the point of the chord line at which the profile has the maximum distance between the pressure-side surface and the suction-side surface is between twenty-five and fifty percent of the length of the chord line;
the fairing comprises a rear part, extending from the through-duct to the trailing edge, said profile comprises a rear section, corresponding to the rear part, and the rear section has a camber of less than ten percent;
the wing portion further comprises a rotor, at least partially housed in the through-duct, the rotor comprising at least one blade capable of adopting a vertical flight position with respect to the through-duct, the suction-side surface and the pressure-side surface are mutually opposite in a direction of the wing portion and the through-duct comprises a cylindrical part facing said blade, the cylindrical part having a height substantially equal to the footprint of the blade in said direction, the blade being in the vertical flight position;
the through-duct comprises a cylindrical portion, an upper lip, connecting the cylindrical part to the suction-side surface, and a lower lip, connecting the cylindrical part to the pressure-side surface, and, on the rear section, the upper lip and the lower lip each have a substantially rounded shape, while the pressure-side surface and the suction-side surface each have a substantially straight portion, respectively in the vicinity of the lower lip and the upper lip;
on the rear section, the distance between the pressure-side surface and the suction-side surface is at its maximum in the vicinity of the through-duct;
on the front section of the profile, the distance between the pressure-side surface and the suction-side surface gradually increases from the through-duct, in the direction of the leading edge;
on the front section of the profile, the distance between the pressure-side surface and the suction-side surface gradually increases from the leading edge, in the direction of the trailing edge;
the maximum distance between the pressure-side surface and the suction-side surface is approximately 250 millimetres.

Other features and advantages of the invention will become apparent from the following description, which is based on illustrative and non-limiting examples, and with reference to the drawings:

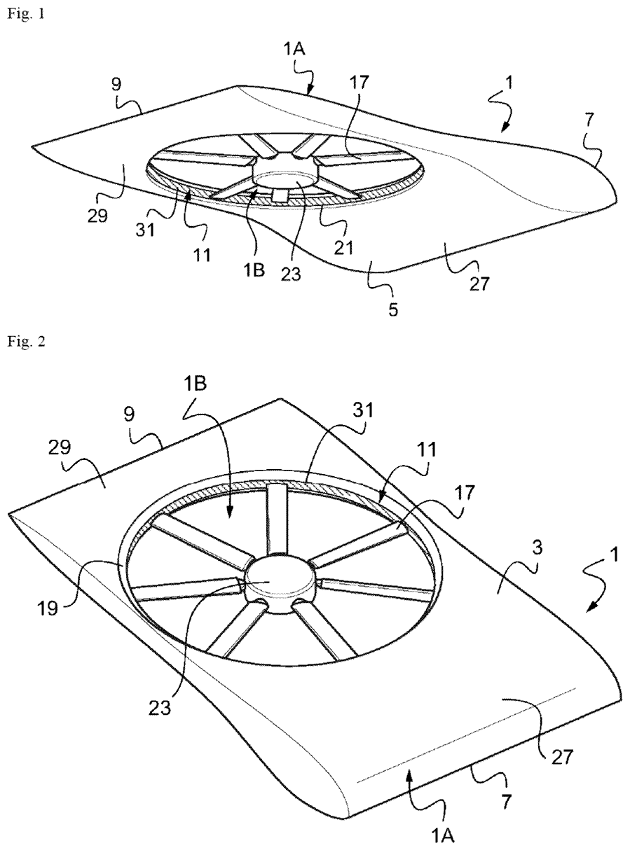

FIG. 1 shows a wing portion according to the invention, in isometric perspective;

FIG. 2 is similar to FIG. 1;

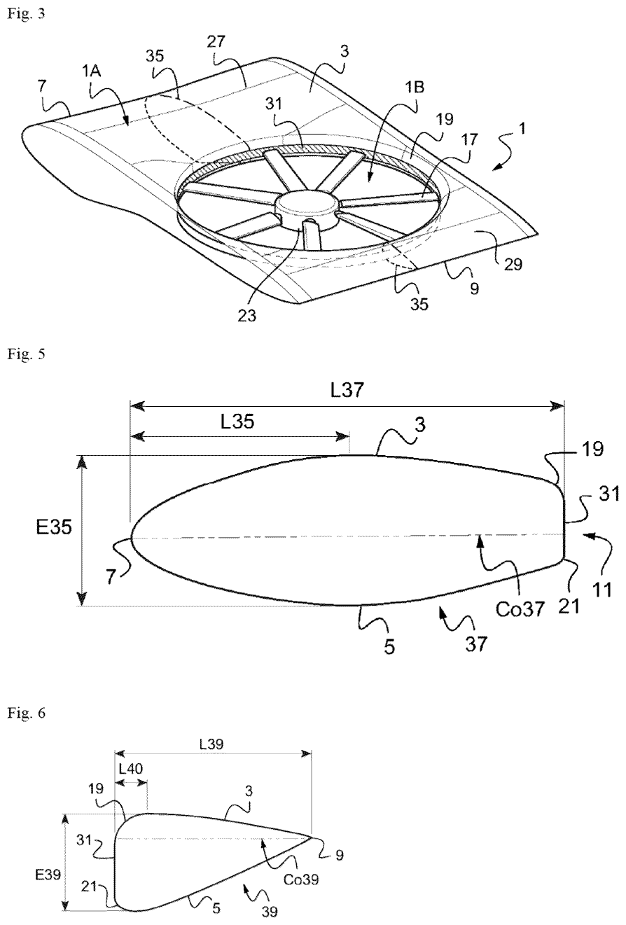

FIG. 3 is similar to FIG. 1;

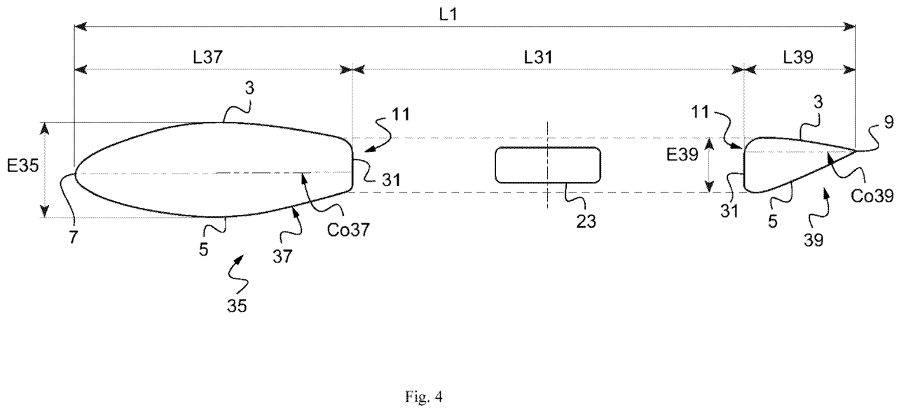

FIG. 4 shows profile of the wing portion shown in FIG. 1;

FIG. 5 shows a detail of FIG. 4;

FIG. 6 shows a detail of FIG. 4;

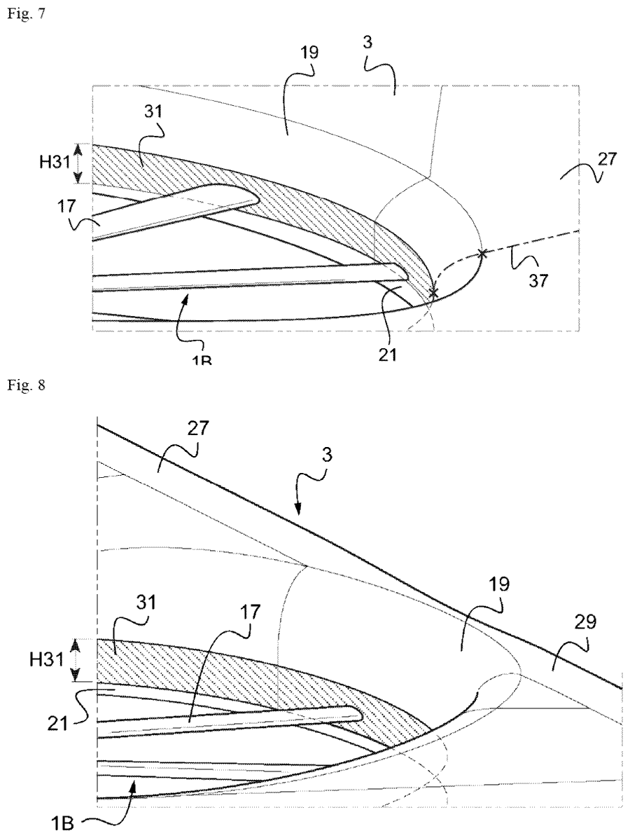

FIG. 7 shows a detail of the wing portion shown in FIG. 1, in isometric perspective;

FIG. 8 is similar to FIG. 7;

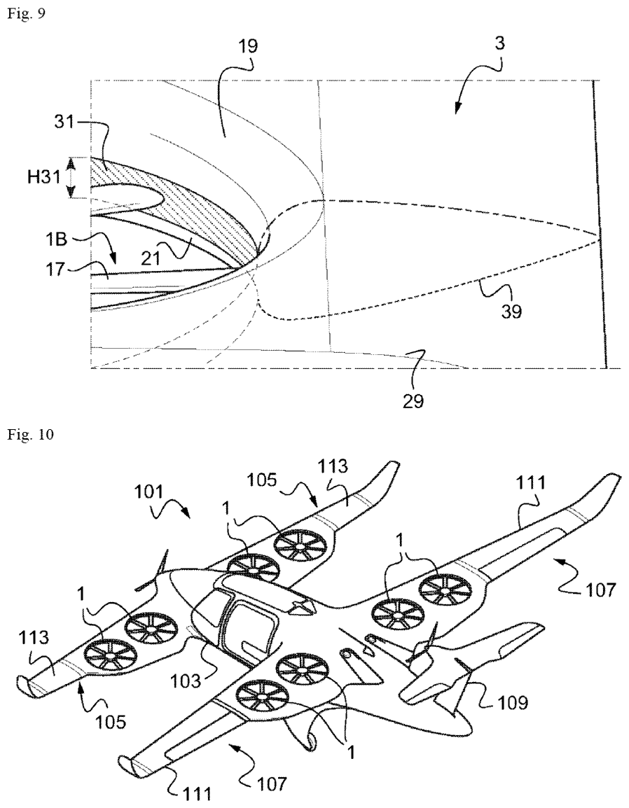

FIG. 9 is similar to FIG. 7;

FIG. 10 shows an exemplary aircraft comprising a plurality of wing portions according to the invention, in isometric perspective;

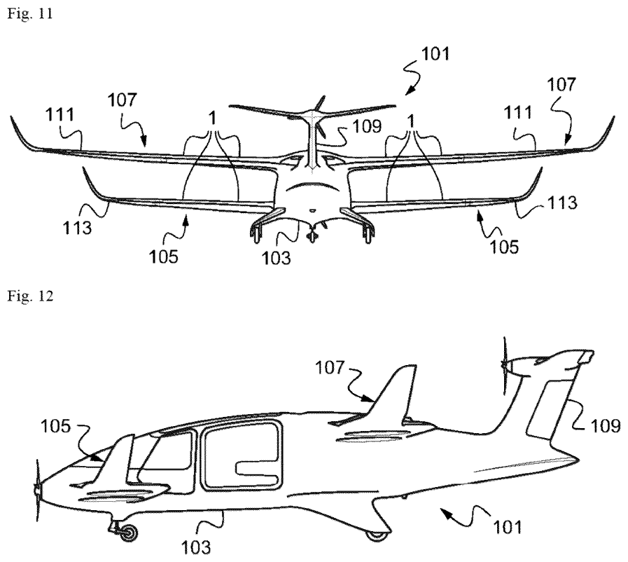

FIG. 11 shows the aircraft shown in FIG. 10, viewed from the rear;

FIG. 12 shows the aircraft shown in FIG. 10, viewed from the side.

The drawings and the description below contain, for the most part, elements of a certain nature. They may therefore not only serve to improve understanding of the present invention, but also contribute to its definition, where appropriate.

Reference is made to FIGS. 1 and 2.

These figures show a wing portion 1 for a VTOL aircraft.

This wing portion 1 comprises a fairing 1A which partially houses a rotor 1B. The wing portion 1 further comprises a stator (not shown), formed so as to support the rotor 1B on the fairing 1A.

The fairing 1A has a front part formed as a leading edge 7 and a rear part formed as a trailing edge 9. The leading edge 7 and the trailing edge 9 are opposite each other in a first direction of the wing portion 1, here the longitudinal direction of the wing portion 1. Here, the distance between the leading edge 7 and the trailing edge 9 in this longitudinal direction is constant over the wing portion 1.

The fairing 1A further has an upper surface formed as a suction side 3 and a lower surface formed as a pressure side 5. The suction side 3 and the pressure side 5 are opposite each other in a second direction of the wing portion 1, here the transverse direction of the wing portion 1. The suction side 3 and the pressure side 5 each connect the leading edge 7 to the trailing edge 9. Here, the distance between the suction side 3 and the pressure side 5 in this transverse direction is variable over the wing portion 1. This distance can be seen as the thickness of the wing portion 1.

The wing portion 1 further comprises a through-duct 11, provided in the fairing 1A and connecting the pressure side 5 to the suction side 3. The through-duct 11 comprises a cylindrical part 31, the visible portion of which is shown with hatching. Here, the cylindrical part 31 has a generally circular cross-section. Here, the cylindrical part 31 has a substantially constant height over its circumference.

The through-duct 11 further comprises a part forming the upper lip 19, connecting the cylindrical part 31 to the suction side 3, and a part forming the lower lip 21, connecting the cylindrical part 31 to the pressure side 5. Here, the upper lip 19 has a substantially rounded profile with a substantially constant curvature around its circumference. Here, the lower lip 21 has a substantially rounded profile with a substantially constant curvature around its circumference.

In general, the through-duct 11 extends mainly in the transverse direction of the wing portion 1. The through-duct 11 partially houses the rotor 1B.

The through-duct 11 is closer to the trailing edge 9 than to the leading edge 7. The minimum distance separating the leading edge 7 from the upper lip 19 (resp. the lower lip 21) is substantially greater than the minimum distance that separates the trailing edge 9 from this lip.

In the vicinity of the through-duct 11, the fairing 1A further has a front part 27, extending from the leading edge 7 to the through-duct 11, and a rear portion 29, extending from the through-duct 11 to the trailing edge 9. The front part 27 and the rear portion 29 are hollow.

The front part 27 of the wing portion 1 houses a spar segment (not shown), or load-bearing beam, which crosses a wing from its root on a fuselage to its tip.

The rotor 1B is held in the through-duct 11 in such a way that its axis of rotation forms an angle of rotor inclination of between approximately 0° and approximately 30° with the transverse direction of the wing portion 1. Here, this angle is close to 0°. The inclination of the axis of rotation of the rotor 1B with respect to the transverse direction of the wing portion 1 improves yaw control. Any plane orthogonal to the axis of rotation of the rotor 1B is called the plane of the rotor.

The rotor 1B comprises a hub 23 and a plurality of blades 17 each mounted on the hub 23 with the ability to pivot. Here, each rotor 1B comprises 7 blades. The blades 17 are inclined relative to the hub 23 and this inclination can be modified during flight, at least as a whole. The end of the blades 17 opposite the hub 23 is free. The tip of a blade 17 forms a blade pitch angle with the planes of the rotor. Here, the blades 17 can be pivoted between a flat position, more efficient in forward flight, corresponding to a blade pitch angle of close to 0°, and an inclined position, more suitable for vertical flight, corresponding to a blade pitch angle between about 20° and about 40°.

The rotational speed of the hub 23 relative to the through-duct 11 can be controlled at different values during flight.

Here, the rotor 1B and the through-duct 11 are arranged in mutual alignment so that the blades 17 are facing the cylindrical part 31 of the through-duct 11, for the flat position and the inclined position. There is a radial clearance between the free end of the blades 17 and the cylindrical part 31 of the duct 11. This clearance is as small as possible, for example between 0.5 and 5 millimetres.

In the prior art, the spar segment is most often placed across the through-duct housing the rotor. On the contrary, in the proposed wing portion 1, the spar segment is positioned in the front part 27, which frees up the through duct 11. Compared to the prior art, the wing portion 1 ensures better performance of the rotor 1B, in particular in vertical flight, and reduces drag, in particular in forward flight. In addition, positioning the spar segment in the front part 27 allows for a thicker spar than in the prior art. In particular, a thicker spar makes it possible to support, at the tip of the wing portion 1, a portion of the wing providing more lift in forward flight. This positioning also makes it possible to reduce the height of the through-duct 11, which here corresponds to the footprint of the blades 17, and not to the thickness of the spar. This further reduces the drag that the through-duct 11 tends to generate in forward flight.

In general, the configuration described here reduces the lift discontinuity on the wing portion 1 generated by the presence of the through-duct 11, and the drag caused by this discontinuity. This configuration also makes it possible to accelerate the transition between the different flight phases, by improving the suction effect in the through-duct 11.

Reference is made to FIGS. 3 to 6.

FIG. 3 shows, in dashed lines, a profile 35 of the fairing 1A, according to a longitudinal section of the wing portion 1 passing through a diameter of the cylindrical part 31. The ends of the cylindrical part 31 are shown as a solid line for the visible parts and as a dashed line for the parts hidden by the fairing 1A. The visible portion of the cylindrical part 31 is hatched.

The section shown in FIG. 3 is a longitudinal section where the through-duct 11 is closest to the leading edge 7. Here, this longitudinal section also corresponds to the section in which the through-duct 11 is closest to the trailing edge 9. FIG. 4 shows this profile 35 and a profile of the hub 23.

The profile 35 has a front section 37 (shown in FIG. 5), corresponding to the front part 27 of the fairing 1A, and a rear section 39 (shown in FIG. 6), corresponding to the rear part 29 thereof. The front section 37 and the rear section 39 respectively have a front chord line Co37 (with front chord value L37), and a rear chord line Co39 (with rear chord value L39). The front chord line Co37 is shown in FIGS. 4 and 5 as a dashed line. The rear chord line Co39 is shown in FIGS. 4 and 6 as a dashed line.

The front chord line Co37 corresponds to the shortest of the straight lines connecting the leading edge 7 to the rear end of the front section 37, here the cylindrical part 31 of the through-duct 11. Here, the front chord value L37 corresponds to the length of the front chord line Co37, and is between 450 and 840 millimetres, for example 700 millimetres.

The rear chord line Co39 corresponds to the shortest of the straight lines connecting the front end of the rear section 39, here the cylindrical part 31 of the through-duct 11, to the trailing edge 9. Here, the rear chord value L39 corresponds to the length of the rear chord line Co39, and is between 200 and 336 millimetres, for example 280 millimetres.

The profile 35 of the fairing 1A has a variable thickness from the leading edge 7 to the trailing edge 9. This thickness assumes a maximum value E35 on the front section 37, at a distance L35 from the leading edge 7. The maximum thickness E35 corresponds to the location of the spar segment. Here, the maximum thickness E35 is between 150 and 270 millimetres, for example 244 millimetres. The distance L35 between the leading edge 7 and the point of the front chord line Co37 at which the profile E35 has the maximum thickness E35 is between twenty-five and fifty percent of the front chord value L37. In FIG. 5, this distance L35 is substantially equal to fifty percent of the front chord value L37.

The front section 37 is tapered near the leading edge 7. Its thickness gradually increases from the leading edge 7 in the direction of the trailing edge 9, until reaching the maximum thickness value E35, then gradually decreases up to the through-duct 11. The rear section 39 has a maximum thickness E39 at a distance L40 from the through-duct 11, then its thickness gradually decreases in the direction of the trailing edge 9. Here, the maximum thickness E39 of the rear section 39 is between 77 and 177 millimetres, for example 97 millimetres. The maximum thickness E39 of the rear section 39 is less than the maximum thickness E35 of the profile 35. In FIG. 6, the maximum thickness E39 of the rear section 39 is located substantially at a point located between fifteen and twenty-two percent of the rear chord line Co39, which corresponds to a distance L40 between this maximum thickness E39 and the through-duct 11 substantially equal to 44 millimetres.

On the profile 35, the suction side 3 and the pressure side 5 are generally symmetrical. The front section 37 and rear section 39 have a front camber Ca37 and a rear camber Ca39, respectively. The front camber Ca37 (resp. the rear camber Ca39) is equal to the ratio of the maximum deflection of the front section 37 (resp. of the rear section 39) to the front chord value L37 (resp. the rear chord value L39). The deflection of the front section 37 (resp. the rear section 39) corresponds to the distance between the front chord line Co37 (resp. the rear chord line Co39), along this chord line, and the mean line of the front section 37 (resp. the rear section 39). The mean line of the front section 37, respectively of the rear section 39, is made up of all the points on this section at equal distances from the pressure side 5 and the suction side 3.

The front camber Ca37 and rear camber Ca39 are both less than ten percent.

FIGS. 4 and 5 show that, on the front section 37 of the profile 35, the suction side 3 and the pressure side 5 are substantially symmetrical. FIGS. 4 and 5 show that, on the front section 37 of the profile 35, the suction side 3 is convex. FIGS. 4 and 5 show that, on the front section 37 of the profile 35, the pressure side 5 is convex.

The cylindrical portion 31 of the through-duct 11 has a diameter L31. Here, this diameter L31 is between 900 and 1350 millimetres, for example 1120 millimetres.

The profile 35 of the wing portion 1 has a footprint in the longitudinal direction of the wing portion 1 of value L1. The footprint value L1 corresponds to the sum of the front chord value L37, the diameter L31 of the cylindrical part 31 and the rear chord value L39. In this case, the footprint value L1 is, for example, 2100 millimetres.

On the front section 37 and the rear section 39 of the fairing 1A, the profiles of the suction side 3 and the pressure side 5 each follow a Bézier curve. The parameters of these curves correspond to characteristic curvature values.

On the front section 37 of the fairing 1A, the curvature of the suction side 3 is minimal in the vicinity of the through-duct 11. This curvature assumes a first characteristic value V1 there. From the through-duct 11, in the direction of the leading edge 7, this curvature gradually increases until, near the location of the spar, a second characteristic value V2 is reached. This value corresponds a local maximum. The curvature of the suction side 3 then decreases slightly before increasing again until it reaches its maximum on the leading edge 7. The curvature assumes a third characteristic value V3 there. Here, these characteristic values V1, V2 and V3 are respectively 4.10⁻³, 1.10⁻³ and 2.10⁻² per millimetre.

The curvature of the pressure side 5 on the front section 37 varies in a similar manner to that described above. This curvature assumes, from the through-duct 11 to the leading edge 7, characteristic values V1′, V2′ and V3′, in this order. Here, these characteristic values V1′, V2′ and V3′ are respectively 3.10⁻⁴, 1.10⁻³ and 2.10⁻² per millimetre.

On the rear section 39 of the fairing 1A, the profile of the suction side 3 has a substantially straight portion, which extends from the upper lip 19 to the trailing edge 9. This profile assumes a first characteristic curvature value V4, near the upper lip 19, and a second characteristic curvature value V5, near the trailing edge 9. Here, these characteristic values V4 and V5 are respectively 1.10⁻³ and 2.10⁻⁴ per millimetre.

On the rear section 39 of the fairing 1A, the profile of the pressure side 5 has a substantially straight portion, which extends from the lower lip 21 to the trailing edge 9. This profile assumes a first characteristic curvature value V4′, near the lower lip 21, and a second characteristic curvature value V5′, near the trailing edge 9. Here, these characteristic values V4′ and V5′ are respectively 3.10⁻² and 1.10⁻⁴ per millimetre.

The profile of the wing portion described above helps reduce drag in the forward flight phase, in particular the component of this drag generated by the thickness of the spar. This profile makes it possible to guide the air flow from the leading edge 7 towards the trailing edge 9 without stall. This profile also improves the guidance of the air flow on the pressure side 5 and the suction side 3 at the inlet and outlet of the rotor 1B, in the vertical flight phase.

Preferably, the positioning and thickness of the spar segment are identical regardless of the longitudinal section of the fairing 1A. In this case, regardless of this section, it has a maximum thickness value close to the maximum thickness value E35 of the profile E35, associated with the same distance L35 from the leading edge 7.

In this case, regardless of the longitudinal section of the fairing 1A, it also has the same longitudinal footprint value L1.

Reference is made to FIGS. 7 to 9.

These figures show details of the through-duct, in the vicinity of the front part 27 (FIG. 7), between the front part 27 and the rear part 29 (FIG. 8) and in the vicinity of the rear part 29 (FIG. 9). The ends of the cylindrical part 31 of the through-duct are shown as a solid line for the visible parts and as a dashed line for the parts hidden by the fairing. The visible portion of the cylindrical part 31 is hatched. FIGS. 7 and 9 show, as dashed lines, part of the front section 37 and the rear section 39 of the profile 35 of the fairing 1A, respectively.

The height H31 of the cylindrical part 31 corresponds to the minimum height for which the blades 17 in the inclined position do not extend beyond the cylindrical part 31 in the transverse direction of the wing portion 1. The height H31 is substantially equal to the footprint of the blades 17 in the inclined position in this transverse direction. Here, this height H31 is substantially equal to 34 millimetres.

Reference is made to FIGS. 10, 11 and 12.

These figures show an exemplary aircraft 101 comprising a plurality of rotor wing portions of the type of wing portion 1 described above.

The aircraft 101 comprises a fuselage 103 provided with a pair of low wings 105 and a pair of high wings 107. The low wings 105 are positioned at the front of the fuselage 103 with respect to the high wings 107. The low wings 105 and high wings 107 are generally parallel to each other, and may be equipped with a winglet at their end. The aircraft 101 further comprises a tail 109, positioned at the rear of the fuselage 103.

Here, each front wing 105 comprises two mutually adjacent rotor wing portions 1 and a wing portion 113 at the wing tip. Each rear wing 107 comprises two mutually adjacent rotor wing portions 1 and a wing portion 111 at the wing tip. The wing portions 113 and 111 have no rotor. Each wing portion 113 and 111 houses a spar segment, substantially similar in position and thickness to the spar segment housed in the adjacent rotor wing portion 1.

The wing portions 113 and 111 increase the lift of the aircraft 101 in forward flight.

According to the tests of the Applicant, the configuration of the rotor wing portions 1 as described above makes it possible to obtain a drag gain of thirty to forty percent relative to a drag value for a similar wing portion, i.e. housing a rotor in a through-duct, without this configuration.

The invention is not limited to the embodiments described above, but encompasses all variants conceivable by a person skilled in the art. In particular:
the through-duct 11 may have an increased overall height, for a constant height value H31 of the cylindrical part 31, so as to increase the performance of the rotor 1B in vertical flight;
the wing portion 1 may have a system for mechanically closing the through-duct 11, to be activated in the forward flight phase;
the trailing edge 9 may be formed so as to follow the shape of the through-duct 11 on the side of the rear part 29.

1. Aircraft wing portion, comprising:
a fairing, having a leading edge and a trailing edge opposite each other, a pressure-side surface and a suction-side surface, opposite each other and each connecting the leading edge to the trailing edge;
the fairing further having a through-duct connecting the pressure-side surface to the suction-side surface, the through-duct being configured to house a rotor, at least partially;
the fairing comprising a front part, extending from the leading edge to the through-duct;
the fairing having a profile with a front section, corresponding to its front part;
wherein the through-duct is closer to the trailing edge than to the leading edge, while the profile has a distance between the pressure-side surface and the suction-side surface that is at its maximum on its front section, this front section having a camber of less than ten percent.

2. The wing portion according to claim 1, wherein the front part houses a spar portion, and wherein the spar portion is closest to the through-duct, the front section has a chord line and the distance between the leading edge and the point of the chord line at which the profile has the maximum distance between the pressure-side surface and the suction-side surface is between twenty-five and fifty percent of the length of the chord line.

3. The wing portion according to claim 1, wherein the fairing comprises a rear part, extending from the through-duct to the trailing edge, said profile comprises a rear section, corresponding to the rear part, and the rear section has a camber of less than ten percent.

4. The wing portion according to claim 1 further comprising a rotor, at least partially housed in the through-duct, the rotor comprising at least one blade configured to adopt a vertical flight position with respect to the through-duct, wherein the suction-side surface and the pressure-side surface are mutually opposite in a direction of the wing portion and the through-duct comprises a cylindrical part facing said blade, the cylindrical part having a height substantially equal to the footprint of the blade in said direction, the blade being in the vertical flight position.

5. The wing portion according to claim 1, wherein the fairing comprises a rear part, extending from the through-duct to the trailing edge, and said profile comprises a rear section, corresponding to the rear part, wherein the through-duct comprises a cylindrical portion, an upper lip, connecting the cylindrical part to the suction-side surface, and a lower lip, connecting the cylindrical part to the pressure-side surface, and wherein, on the rear section, the upper lip and the lower lip each have a substantially rounded shape, while the pressure-side surface and the suction-side surface each have a substantially straight portion, respectively in the vicinity of the lower lip and the upper lip.

6. The wing portion according to claim 1, wherein the fairing comprises a rear part, extending from the through-duct to the trailing edge, and said profile comprises a rear section, corresponding to the rear part, wherein, on the rear section, the distance between the pressure-side surface and the suction-side surface is at its maximum in the vicinity of the through-duct.

7. The wing portion according to claim 1, wherein, on the front section of the profile, the distance between the pressure-side surface and the suction-side surface gradually increases from the through-duct, in the direction of the leading edge.

8. The wing portion according claim 1, wherein, on the front section of the profile, the distance between the pressure-side surface and the suction-side surface gradually increases from the leading edge, in the direction of the trailing edge.

9. The wing portion according to claim 1, wherein the maximum distance between the pressure-side surface and the suction-side surface is approximately 250 millimetres.

10. The wing portion according to claim 1, wherein, on the front section of the profile, the suction-side surface and the pressure-side surface are substantially symmetrical.

11. The wing portion according to claim 1, wherein, on the front section of the profile, the suction-side surface is convex and the pressure-side surface is convex.

12. Aircraft wing comprising at least one wing portion according to claim 1.

13. Aircraft comprising one or more aircraft wings according to claim 12.
